(19) United States
(12) Patent Application Publication
(10) Pub. No.: US 2026/0140703 A1
(43) Pub. Date: May 21, 2026

(54) SYSTEMS AND METHODS FOR LARGE LANGUAGE MODEL-BASED SOFTWARE DEVELOPMENT AND ANALYSIS TOOL

(71) Applicant: ServiceNow, Inc., Santa Clara, CA (US)

(72) Inventor: Sagar Gupta, Bangalore (IN)

(21) Appl. No.: 18/952,379

(22) Filed: Nov. 19, 2024

(51) Int. Cl. G06F 8/30

(52) U.S. Cl. CPC G06F 8/30

(57) ABSTRACT

A method includes receiving, from a client device associated with an enterprise, information regarding software code, generating, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library, and providing, to the client device, the recommendation.

### TECHNICAL FIELD

The present disclosure relates generally to software code development and analysis.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

As open-source software becomes more prevalent, it is increasingly common for software to be developed using publicly available code libraries and portions of code. However, public repositories for code libraries and/or individual portions of code may not provide contextual information about the characteristics of code libraries and/or portions of code in the repository, or such information may be provided in a way that is inefficient to process. Accordingly, software development may utilize code libraries and/or portions of code from one or more public repositories that are not well suited to the goals of the software being developed (e.g., performance, security, scalability, energy efficiency). Further, developed software and software updates may be provided to client devices with limited release notes or release notes that contain so much information that they are difficult to understand.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving, from a client device associated with an enterprise, information regarding software code, generating, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library, and providing, to the client device, the recommendation.

In another embodiment, a system includes processing circuitry and a memory, accessible by the processing circuitry. The memory stores instructions that, when executed by the processing circuitry, cause the processing circuitry to execute a client instance. The client instance is configured to receive, from a client device associated with an enterprise, information regarding software code, generate, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library, and provide, to the client device, the recommendation.

In a further embodiment, a non-transitory, computer readable medium stores instructions that, when executed by processing circuitry, cause the processing circuitry to receive, from a client device associated with an enterprise, information regarding software code, generate, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library, and provide, to the client device, the recommendation.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance that hosts a software code development and analysis tool, in accordance with aspects of the present disclosure;

FIG. 5 is a flow chart of a process including various stages of use of the software code development and analysis tool of FIG. 4, in accordance with aspects of the present disclosure;

FIG. 6 is a flow chart of a process for library profiling via the software code development and analysis tool of FIG. 4, in accordance with aspects of the present disclosure;

FIG. 7 is a flow chart of a process for guiding software development via the software code development and analysis tool of FIG. 4, in accordance with aspects of the present disclosure; and

FIG. 8 is a flow chart of a process for providing analysis of shipped code via the software code development and analysis tool of FIG. 4, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As open-source software becomes more prevalent, it is increasingly common for software to be developed using publicly available code libraries and portions of code. However, public repositories for code libraries and/or individual portions of code may not provide contextual information about the characteristics of code libraries and/or portions of code in the repository, or such information may be provided in a way that is inefficient to process. Accordingly, software development may utilize code libraries and/or portions of code from one or more public repositories that are not well suited to the goals of the software being developed (e.g., performance, security, scalability, energy efficiency). Further, developed software and software updates may be provided to client devices with limited release notes or release notes that contain so much information that they are difficult to understand.

Various embodiments disclosed herein are directed to software development and analysis using large language models (LLMs). Prior to using an LLM-based tool for software development and software analysis, a library profiling process is performed. Specifically, code libraries used by an enterprise may be analyzed based on various factors, such as energy consumption to execute code, performance, use cases, etc. In some embodiments, libraries from open source or other publicly available repositories may be analyzed to create baselines and/or expand sample sizes. In such embodiments, application programming interfaces (APIs) may be utilized to extract metadata indicative of usage patterns, to collect data from logs, and/or to survey data about usage. Static analysis tools may then be used to parse code, identify library dependencies, and so forth. Profiles may be generated for libraries identifying various characteristics of the respective library. For example, an energy profile may identify energy consumption during typical operations, energy cost/consumption per operation, and compare energy consumption/efficiency to other similar libraries. Similarly, a performance profile may identify execution times to perform certain tasks, resource usage, and so forth. In some embodiments, benchmark tests may be performed to confirm and/or inform the library profiles. Based on the profiles, a multi-criteria decision analysis (MCDA) may be performed to score or rank the various libraries in the various characteristics based on weighting factors. The MCDA may be used to recommend libraries for various tasks or use cases. One or more LLMs may be trained using code samples, available libraries, the profiles, user feedback, training data sets, and so forth.

The LLM-based tool may be used by developers during software development. For example, prior to any code being written, the tool may receive inputs describing target characteristics of software to be developed, planned features, etc. and the tool may provide outputs recommending specific libraries, code structures, and so forth. Further, during development, code may be provided via a plugin or API and analyzed. A static analysis of the code may include analyzing the code for known inefficiencies. A dynamic analysis may include running test cases to assess performance, energy consumption, execution time, deviations from security policies and/or security best practices, and so forth in an execution environment. The tool may then be configured to generate various outputs to be used during development. For example, the tool may generate or suggest code snippets to adapt the code to different runtime contexts, reduce performance bottlenecks, convert sequential code into parallel code, implement efficient concurrency patterns, etc. The tool may also be utilized to enhance security by detecting security vulnerabilities, suggesting code adjustments to mitigate security threats, and generating code that follows security policies and/or security best practices. The tool may also be used to improve code maintainability and readability by providing suggestions to simplify complex code structures, generating comments and/or documentation explaining code segments'purpose and functionality, suggesting modifications for compliance with coding standards, performing code review to identify deviations from best practices and suggest corrections, etc. The tool may be used to improve resource usage by recommending more efficient data structures, suggesting improvements to memory allocation/deallocation, suggesting improvements to minimize network usage, suggesting efficient handling of input/output (I/O) operations to reduce latency and increase throughput, etc. The tool may be used to improve scalability and deployment by providing recommendations on breaking down monolithic applications into microservices to enhance scalability, generating cloud-ready code that utilizes auto-scaling, load balancing, and so forth, generating deployment scripts for deploying the code across multiple environments, suggesting improvements in continuous integration, continuous delivery (CICD) pipelines to streamline code integration and deployment. The tool may be used to improve user experience and responsiveness by suggesting changes to make software more accessible and adhere to standards, providing suggestions for better performance across various devices and screen sizes, analyzing user interaction data and user feedback to recommend changes to the code to enhance the user experience.

Additionally, the tool may be used by consumers to analyze shipped code. For example, the tool may receive a file or identification of a particular software version and a request for specific analysis. For example, the tool may be configured to provide an explanation of differences between the software version and a prior version (e.g., the previous version or an even earlier version). For example, the tool may provide an explanation as to characteristics of a software update and provide a recommendation as to whether the software update should be installed and/or identify possible conflicts or problems that may arise by installing the update.

Use of the disclosed techniques may provide a more objective, quantitative analysis of software code, resulting in software that is better suited for its objectives. Accordingly, software developed and deployed using the tool may be higher performing, more efficient, more secure, more scalable, or a combination thereof.

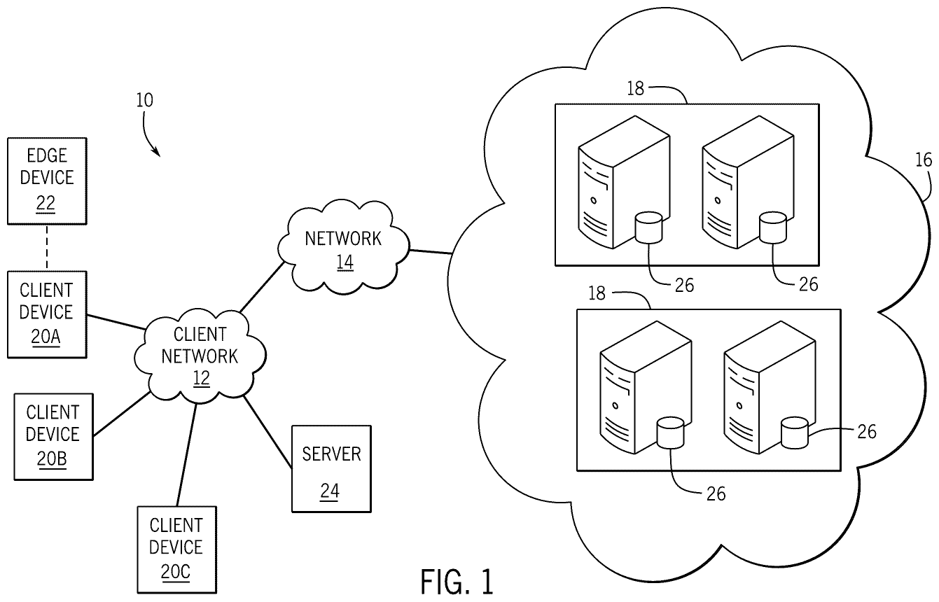

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

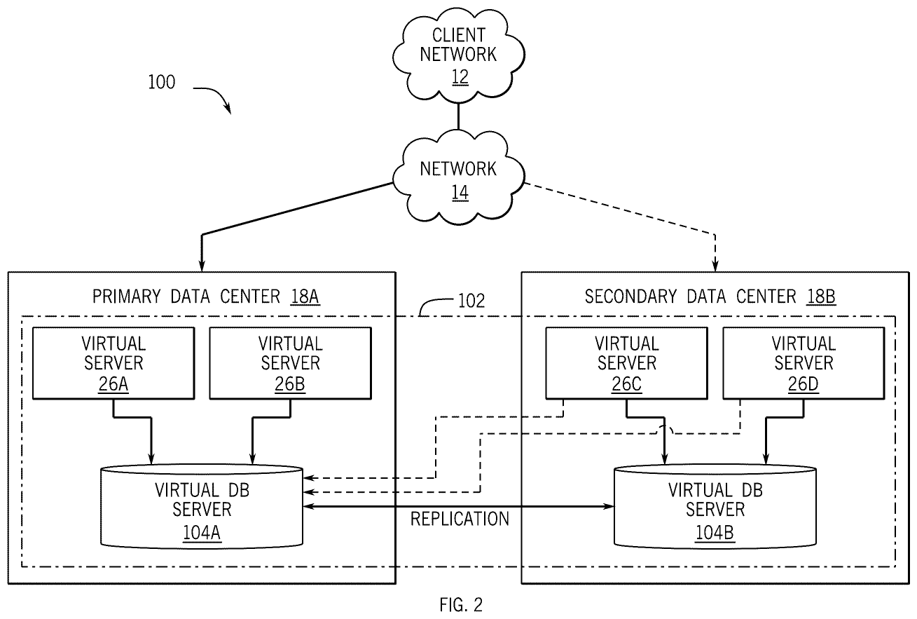

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

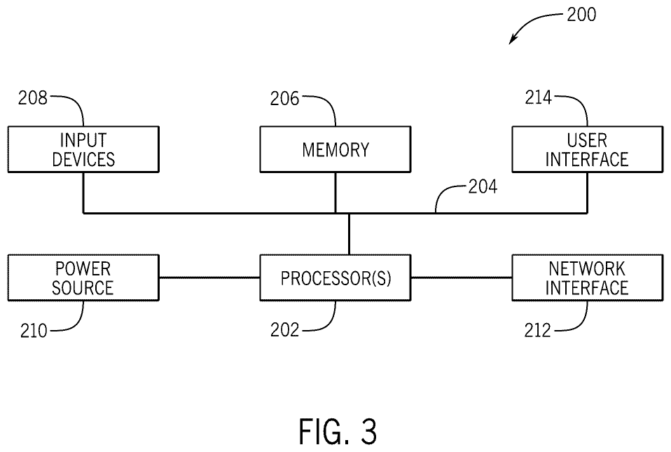

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

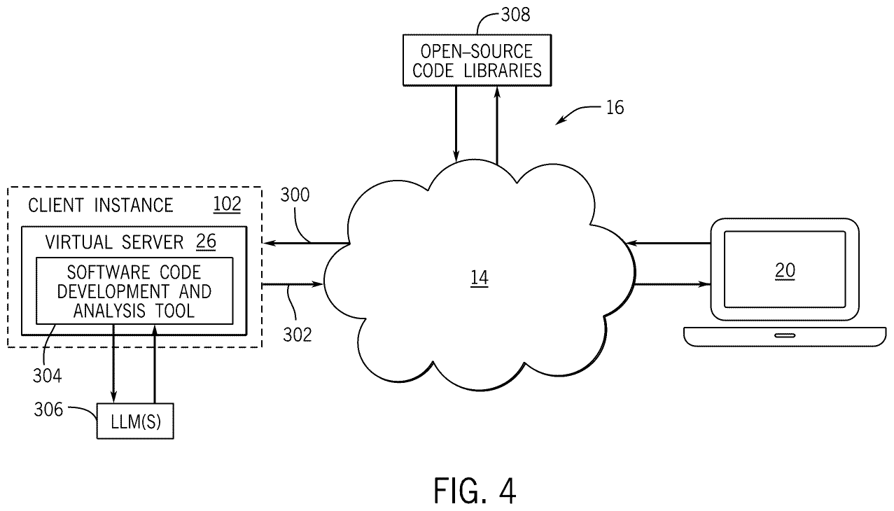

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser, a native application running on the client device 20, etc.). The client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in shown in FIG. 4, the virtual server 26 of the client instance 120 may run a software code development and analysis tool 304, which may be a software application defined by code, accessible via a native application or web browser of the client device 20. Accordingly, the inputs 300 may include inputs requesting guidance on code development (e.g., suggested libraries, code structures, etc.), analysis of accompanying code, generation of new code, analysis of shipped code, versions of code, and/or files, and so forth. Correspondingly, the outputs 302 may include requested recommendations for specific code libraries or structures, analysis of code, summaries of code, generated code snippets, and so forth as responses to inputs 300, questions, and so forth. The software code development and analysis tool 304 may utilize one or more large language models 306 (LLMs), which may be accessible to the client instance 102 (e.g., stored in another instance, stored on the same instance, stored in the cloud, stored on one or more servers, etc.), to generate some or all of the outputs 302.

As used herein, an LLMs is a probabilistic model of a natural language used for general-purpose language generation. LLMs typically include one or more artificial neural networks having a transformer-based architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with code development and/or analysis, as well as tasks beyond the scope of code development and/or analysis.

Among other things, the client device 20 may be used to perform software development. As open-source software becomes more prevalent, it is increasingly common for software to be developed using publicly available code libraries, such as open-source code libraries 308. However, open-source code libraries 308 may provide limited or no contextual information about the characteristics of code stored in respective libraries, resulting in code from the open-source code libraries 308 being used that does not align with the goals of the software being developed (e.g., performance, security, scalability, energy efficiency, etc.). For example, a software library developed for high performance may be unknowingly used in a software product targeting energy efficiency in which the high-performance software library may utilize excessive computing resources to achieve high performance, thus reducing the energy efficiency of the software product. It should be understood, however, that this is merely one example and that other examples of mismatched characteristics of software libraries and software products are also possible. Accordingly, the software code development and analysis tool 304 may be used during software development to better achieve the goals of the software being developed.

As used herein, a software library is a collection of pre-written code, functions, and other resources that developers can use to develop and implement computer programs. Libraries can be used to perform common computing tasks, such as handling inputs, interacting with a database, parsing data, and so forth. Software libraries can be used by an organization to promote code reuse across multiple projects within an organization, leading to increased productivity and efficiency. Software libraries may include, for example, source code, subroutines/functions, classes, non-executable data (e.g., images and/or text). Use of open-source libraries are governed by respective open-source licenses, which allow the software in the library to be reused, modified, published, etc. without permission, but may put other conditions on such activities.

Prior to providing guidance in development decisions, the software code development and analysis tool 304 may perform a library profiling process. The software code development and analysis tool 304 may receive (e.g., from the client device 20) an input 300 including an indication of one or more code libraries used in software development. The indicated libraries may be retrieved and analyzed based on one or more factors (e.g., energy consumption, performance, use cases, etc.). In some embodiments, the software code development and analysis tool 304 may also retrieve and analyze one or more open source or other publicly available repositories (e.g., open-source code libraries 308) as baselines and/or to expand sample size. The software code development and analysis tool 304 may retrieve (e.g., via one or more application programming interfaces (APIs)) metadata indicative of usage patterns, log data, usage survey data, etc. for analysis. The software code development and analysis tool 304 may perform static analysis by parsing code and identifying dependencies between libraries. The software code development and analysis tool 304 develops one or more profiles for each of the analyzed libraries that characterize various characteristics or key performance indicators (KPIs) of the respective library. For example, an energy profile may identify energy consumption during typical operations, energy cost/consumption per operation, and compare energy consumption/efficiency to other similar libraries. A performance profile may identify execution times to perform certain tasks, resource usage, and so forth. In some embodiments, the software code development and analysis tool 304 may run benchmark tests to confirm and/or inform the library profiles.

The software code development and analysis tool 304 may perform a multi-criteria decision analysis (MCDA) to score and/or rank the various libraries in the various characteristics or KPIs based on weighting factors. The software code development and analysis tool 304 may use the MCDA to recommend libraries for various tasks and/or use cases. In performing the library profiling process, the software code development and analysis tool 304 may or may not utilize the one or more LLMs 306.

During development, the software code development and analysis tool 304 may receive inputs 300 from the client device 20 requesting guidance on various aspects of development and/or analysis of code. For example, in the early stages of development (e.g., prior to any or a substantial amount of code being written), the client device 20 may provide inputs 300 to the software code development and analysis tool 304 identifying target characteristics of software being developed, planned features, and so forth. The software code development and analysis tool 304 may utilize the LLMs 306 to generate outputs 302 recommending specific libraries, code structures, and other characteristics of the code being developed based on the inputs. Additionally, during development, the client device 20 may provide inputs 300 to the software code development and analysis tool 304 requesting analysis of code provided with the input 300, linked to the input 300, provided via API, provided via plugin, or some other way.

The software code development and analysis tool 304 may (e.g., via the LLMs 306) perform a static analysis of the provided code by analyzing the code as provided for known inefficiencies. The software code development and analysis tool 304 may then perform a dynamic analysis of the provided code by running test cases to assess various characteristics of the code (e.g., performance, energy consumption, execution time, deviations from security policies and/or security best practices, and so forth). Based on the analysis, the software code development and analysis tool 304 may generate one or more outputs 302 that include results of the analysis, such as code snippets to adapt the code to different runtime contexts, reduce performance bottlenecks, convert sequential code into parallel code, implement efficient concurrency patterns, etc. The software code development and analysis tool 304 may also use the analysis to enhance security by detecting security vulnerabilities, suggesting code adjustments to mitigate security threats, and generating code that follows security policies and/or security best practices. Further, the software code development and analysis tool 304 may use the analysis to improve code maintainability and readability by providing suggestions to simplify complex code structures, generating comments and/or documentation explaining code segments'purpose and functionality, suggesting modifications for compliance with coding standards, performing code review to identify deviations from best practices and suggest corrections, etc. The software code development and analysis tool 304 may also be configured to use the analysis to improve resource usage by recommending more efficient data structures, suggesting improvements to memory allocation/deallocation, suggesting improvements to minimize network usage, suggesting efficient handling of I/O operations to reduce latency and increase throughput, etc. The software code development and analysis tool 304 may further be configured to use the analysis to improve scalability and deployment by providing recommendations on breaking down monolithic applications into microservices to enhance scalability, generating cloud-ready code that utilizes auto-scaling, load balancing, and so forth, generating deployment scripts for deploying the code across multiple environments, suggesting improvements in continuous integration, continuous delivery (CI/CD) pipelines to streamline code integration and deployment. The software code development and analysis tool 304 may additionally be configured to use the analysis to improve user experience and responsiveness by suggesting changes to make software more accessible and adhere to standards, providing suggestions for better performance across various devices and screen sizes, analyzing user interaction data and user feedback to recommend changes to the code to enhance the user experience.

In some embodiments, the software code development and analysis tool 304 may be used to analyze shipped code, new versions of shipped code, updates to shipped code, etc. For example, the client device 20 may provide the software code development and analysis tool 304 with a file, a link to a file, or a reference to a particular software version/update and a request for specific analysis (e.g., identifying differences between new and pervious versions, identifying changes made in an update, assessing compatibility with existing hardware and/or software, etc.). Accordingly, the software code development and analysis tool 304 may be used to generate outputs 302 that make recommendations and/or inform decisions regarding whether the software or update should be installed and/or identify possible conflicts, problems, or consequences that may arise by installing the software or update.

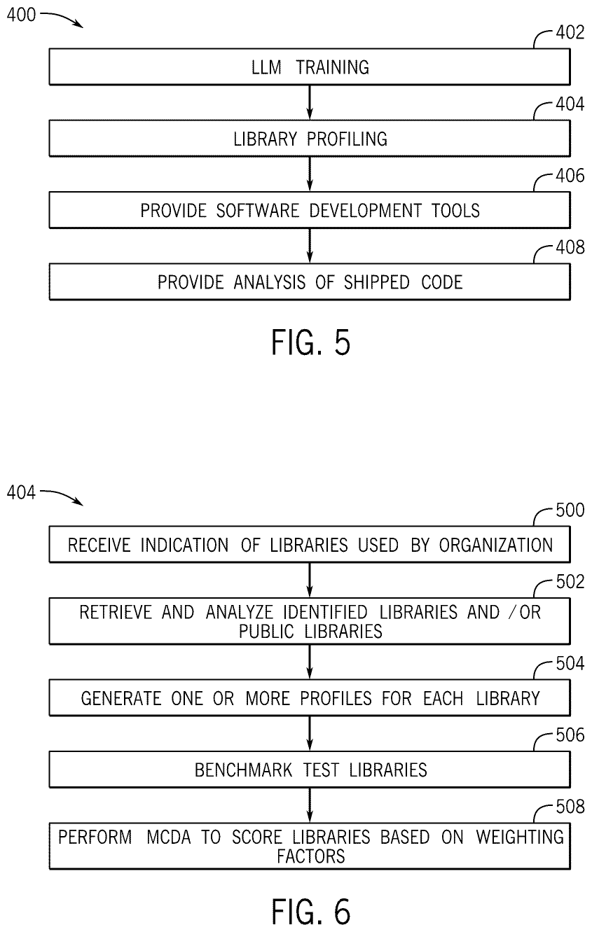

FIG. 5 is a flow chart of a process 400 including various stages of use of the software code development and analysis tool. It should be understood, however, that though the various stages are shown in a particular order, that the software code development and analysis tool may not proceed through the stages in the order shown and may indeed transition from one stage to another, in any order, as the software code development and analysis tool receives requests and/or commands to perform various tasks.

At stage 402, the one or more LLMs are trained. Training may include, for example, data collection and preparation, generating a training data pipeline, model training, and evaluation/feedback. During data collection and preparation, the process 400 may collect diverse code samples, which may include various libraries and frameworks from the enterprise's own libraries and/or from publicly available code libraries (e.g., open-source libraries). The process 400 may also collect energy consumption data for the collected samples (e.g., how much energy is used to execute the code samples). If such data is not available, the process 400 may run a performance analysis of libraries used in training samples. Further, the process 400 may collect examples of code snippets and energy savings associated with the code snippets.

Generating the training data pipeline may include preprocessing in which the process 400 cleans and normalizes the code samples, annotating energy consumption data, security data, performance data, and standardizing the data formats. Additionally, generating the training data pipeline may further include feature extraction, during which the process 400 extracts relevant features from collected data, such as library calls, code complexity, and runtime behaviors.

During model training, the process 400 may perform initial training, fine tuning, reinforcement learning, and evaluation/feedback. During initial training, the process 400 uses general code and datasets to train the LLM on recognizing and suggesting code modifications. During fine tuning, the process 400 adjusts the model with specific datasets (e.g., identified by a user) to perform library comparisons focused on corresponding characteristics or KPIs, such as energy efficient coding practices, performance, security, etc. During reinforcement learning, the process 400 uses reinforcement learning to refine the model using feedback from real-world applications and performance data.

During evaluation/feedback, the process utilizes performance metrics (e.g., evaluating the model's accuracy in suggesting efficient code and/or libraries), user feedback (e.g., feedback from developers to continually improve recommendations), and impact assessments (e.g., measuring actual energy consumption reduction, performance improvements, and/or security improvements achieved using recommendations and or snippets to suggest a balance of factors set by a user).

At 404, the process 400 performs library profiling. As previously described, and as is described in more detail with regard to FIG. 6, library profiling may involve analyzing libraries to generate one or more profiles for each library that characterize various aspects of each library, such as energy efficiency, performance, security, etc.

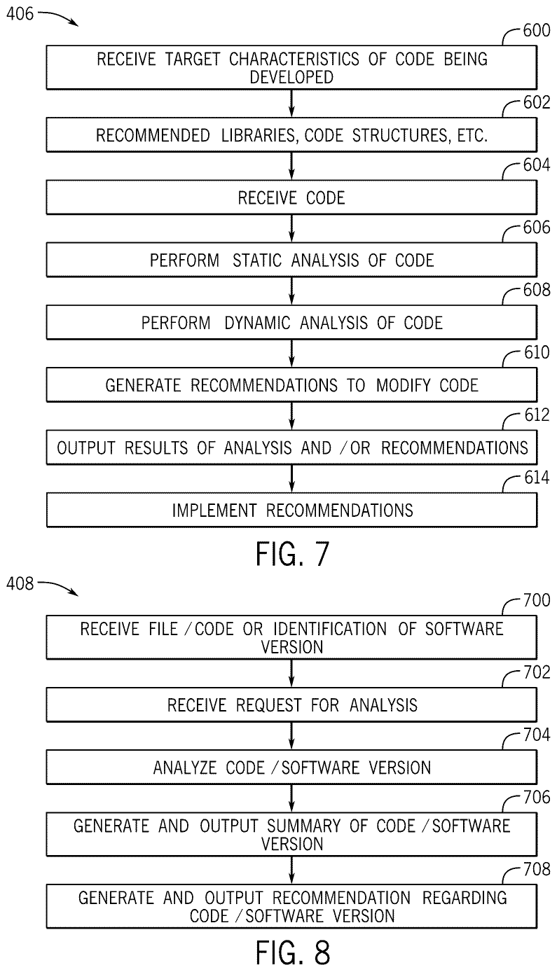

At 406, the process 400 provides tools during software development. As previously described, and as is described in more detail with regard to FIG. 7, providing software development tools may involve recommending specific libraries and/or code structures for code to be developed, analyzing provided code, generating recommendations to modify the provided code, and, in some cases, implementing recommendations.

At 408, the process 400 provides analysis of shipped code. As previously described, and as is described in more detail with regard to FIG. 8, providing analysis of shipped code may involve analyzing a portion of code, a file, a software version, and update, etc., generating a summary of the code, file, version, update, etc. and providing a recommendation regarding the code, file, version, update, etc.

FIG. 6 is a flow chart of a process 404 for library profiling via the software code development and analysis tool. At 500, the process 404 receives an indication of libraries used by the organization. The indication may come from the client device, from a database, and indication of one or more code repositories used by the organization, crawling code storage, etc. At 502, the process 404 retrieves and analyzes the identified libraries and/or one or more public libraries as baselines. For example, the process 404 may analyze popular public repositories to understand how libraries are used across various projects. In some embodiments, the process 404 may utilize APIs from code repositories to extract metadata and usage patterns. The analysis may include using static analysis tools to parse code and identify dependencies within and/or between libraries, as well as usage contexts. Further, the process 404 may utilize dependency checks to scan projects and create maps of library usage between projects. The process 404 may further collect data from user logs and/or user surveys to understand library usage in projects.

At 504, the process 404 generates one or more profiles for each of the retrieved libraries. For example, the process 404 may generate an energy profile for each library by identifying everyday operations performed using the library, measuring or collecting information about the energy consumption to perform the operations, and comparing libraries offering similar functionality to determine which libraries are most energy efficient. In another example, the process 404 may generate a performance profile for each library by collecting and analyzing performance metrics for the library, including, for example, execution time to perform specific tasks, and resource usage (e.g., CPU usage, memory usage, disk I/O usage, etc.). It should be understood, however, that these profiles are merely examples that that the process 404 may generate other profiles for assessing other characteristics of the libraries (e.g., security, maintainability, readability, accessibility, scalability, deployment, user interface (UI), user experience (UX), etc.). By profiling libraries, use of the disclosed techniques may provide developers with a better understanding of the characteristics of libraries used in development.

At 506, the process 404 performs benchmark tests on the retrieved libraries. Benchmark tests mimic normal usage scenarios for each library. The process 404 may generate synthetic workloads for benchmark testing and create controlled, repeatable tests that stress various aspects of the retrieved libraries (e.g., throughput, latency, resource usage, etc.). The process may also utilize available performance profiling tools during benchmark testing. These performance profiling tools may measure, for example, CPU usage, memory usage, I/O usage, etc. during various operations performed by the library. Benchmark testing may also involve using available power measurement tools to measure power consumption of the retrieved libraries during execution. In some embodiments, the process 404 may also utilize hardware-based monitoring or APIs provided by cloud platforms to track energy usage by applications running the retrieved libraries. During benchmark testing, the process 404 may further utilize simulators to estimate energy consumption using resource utilization metrics. For example, the process 404 may utilize emulators with built-in power estimation capabilities for mobile libraries.

At 508, the process 404 performs multi-criteria decision analysis (MCDA) to score the retrieved libraries so the libraries can be ranked to develop alternate recommendations. For example, the process 404 may balance various factors, such as energy efficiency, performance, security, functionality, etc. to rank the retrieved libraries. The process 404 utilizes a scoring system to rank the libraries based on the various profiles. In some embodiments, weighting factors may be assigned to various characteristics or KPIs of the libraries reflected in the profiles (e.g., weight energy efficiency over performance). The process 404 may perform analysis in real-time or near real-time such that recommendations can be provided to developers quickly during the development process.

FIG. 7 is a flow chart of a process 406 for providing software development tools. At 600, the process 406 receives one or more target characteristics of code being developed. This may include, for example, a function the code performs (e.g., a game, photo editing, social media, video/music streaming, finance, shopping, navigation, news, smart home control, fitness tracking, list making, document management, etc.), a type of device on which the code runs (e.g., mobile device, tablet, desktop/laptop computer, server, cloud, etc.), performance priorities (e.g., energy efficiency, performance, accessibility, secure, scalable, maintainability, etc.), and so forth. At 602, the process 406 may utilize one or more LLMs to recommend code libraries, code structures, etc. for developing the code. Use of the disclosed techniques results in code being developed with libraries and code structures that are better suited to the objectives of the code being developed, resulting in code that has improved performance, uses fewer computing resources when executed, is more secure, is more maintainable, is more scalable, and provides a better user experience than would otherwise be the case.

At 604, the process 406 may receive code from a client device. The code may be received via an integrated design environment (IDE) plugin, via an API in a continuous integration (CI)/continuous delivery (CD) pipeline, or via some other mechanism.

At 606, the process 406 performs a static analysis of the code in which the process evaluates the code for known inefficiencies, errors, violations of policies and/or best practices, and so forth. At 608, the process 406 performs dynamic analysis by running the code on test cases to measure real-time issues, such as energy consumption, execution time, deviations from security best practices, etc.

At 610, the process 406 uses the LLMs to generate recommendations to modify the code using tuning techniques based on the target characteristics and/or based on specific characteristics identified by the user as important. For example, for performance tuning, the process 406 may perform context-aware code generation, parallel processing and concurrency, and so forth. For context-aware code generation, the process 406 may use the LLM to perform dynamic adaptation by generating and/or suggesting code snippets that adapt to various runtime contexts by adjusting for CPU, memory constraints, network conditions, etc. Further, the process 406 may perform profiling and refactoring by analyzing existing code to identify performance bottlenecks and refactor the code for improved speed and efficiency. With regard to parallel processing and concurrency, the process 406 may perform automated parallelism by using the LLM to convert sequential code into parallel code to adapt the code for multi-core processors. Further, the process 406 may suggest efficient concurrency patterns (e.g., non-blocking I/O or multi-threading) tailored to the application's workload.

For security enhancement, the process 406 may integrate LLMs during static code analysis to detect security vulnerabilities in code (e.g., SQL injection, cross cite scripting (XSS), buffer overflows, etc.) and suggest alternative coding strategies. Further, the process 406 may analyze runtime behaviors during dynamic security testing to suggest code adjustments to mitigate security vulnerabilities. The process 406 may also utilize the LLMs in secure code generation to enhance context-sensitive security by generating code that inherently follows security best practices and adapting recommendations based on the application's specific security guidelines.

For maintainability and readability, the process 406 may perform code simplification by providing automated refactoring suggestions to simplify complex code structures, resulting in more maintainable code structures. Further, the process 406 may (e.g., via the LLMs) autogenerate and insert comments and documentation explaining code segments'purpose and functionality. The process 406 may further suggest and enforce coding standards tailored to the specific project's guidelines and/or industry norms, standards, and/or best practices. The process 406 may also perform an automated code review by using the LLMs to review the code, identify deviations from best practices, and suggest modifications to bring the code into compliance with the best practices.

For resource usage, the process 406 may consider memory and storage efficiency, as well as network and I/O tuning. For example, the process 406 may perform data structure tuning by recommending more efficient data structures to improve memory usage and/or make memory usage more efficient. Further, the process 406 may suggest improvements in memory allocation and deallocation to minimize memory leaks and tune memory usage. Regarding network, the process 406 may (e.g., via the LLMs) generate code that minimizes network usage and tunes data transfer protocols and compression techniques. Regarding I/O tuning, the process 406 may suggest more efficient handling of I/O operations to reduce latency and increase throughput.

For scalability, the process 406 may provide guidance on a scalable architecture design by providing recommendations for breaking monolithic applications into microservices to improve scalability. Further, the process 406 may (e.g., via the LLM) generate cloud-ready code that leverages autoscaling, load balancing, and other cloud-native features.

For deployment, the process 406 may (via the LLMs) create deployment scripts that facilitate smooth and efficient deployment across different environments. For continuous integration enhancements, the process 406 may (e.g., via the LLM) recommend improvements to CI/CD pipelines to streamline code integration and deployment processes.

For user interface (UI) and user experience (UX) tuning, the process 406 may (e.g., via the LLM) recommend changes to code to make the application more accessible and adhere to Web Content Accessibility Guidelines (WCAG), as well as recommending modifications to the code to improve performance on various devices and screen sizes. For user interaction patterns, the process 406 may perform behavioral analysis by analyzing user interaction data and suggest modifications to the code to enhance user engagement and satisfaction. Further, the process 406 may provide real-time or near-real-time feedback in the form of recommendations, insights, and/or adjustments based on user feedback and interaction analytics.

Use of the disclosed techniques results in code being developed in a way that is more targeted to development objectives by providing a developer with better insights into how various portions of code and/or libraries work and the various characteristics of the code and/or libraries. Accordingly, use of the disclosed techniques may result in code that has improved performance, uses fewer computing resources when executed, is more secure, is more maintainable, is more scalable, and provides a better user experience than would otherwise be the case.

At 612, the process 406 outputs the results of the analysis and/or the generated recommendations. In some embodiments, providing the recommendation may include generating a graphical representation of the recommendation that is displayable on the client device. For example, the recommendation may include a recommendation to change the software code from using one software library to using another software library based on the profiles for the libraries. In some embodiments, the user may implement the recommendations on their own and/or make decisions based on the outputs of the analysis. However, in other embodiments, the recommendations may include selectable options to automatically implement the recommendations (e.g., modify code, change libraries, adjust code structures, replace portions of code, etc.). Accordingly, in such embodiments, the process 406 may automatically implement one or more of the recommendations, or implement one or more of the recommendations upon selection or approval by the user at 614.

As time progresses, the software code development and analysis tool may use feedback on library updates from users/providers, as well as feedback from other teams, to generate recommendations that highlight benefits of library migration and/or changes in a library's energy consumption and carbon emissions.

FIG. 8 is a flow chart of a process 408 for providing analysis of shipped code via the software code development and analysis tool. At 700, the process 408 receives a portion of code, a file, or an identification of a software version, update, etc. As previously described, an actual portion of code or a file may be uploaded or otherwise provided via an API, a portal, etc. In other embodiments, the process 408 may merely receive an indication of a particular version of software or an update to software by identifying a version number or update number and/or a release date. At 702, the process 408 receives a request for analysis. The request may include a request for a summary of the code, identification of differences between the indicated version and previous versions, a compatibility check between the code and other code being used by the enterprise, a recommendation whether to install the code, etc. At 704, the process 408 performs the requested analysis. In some embodiments, the process 408 may utilize the LLMs to perform some or all of the analysis. At 706, the process 408 may generate and output a summary of the code, update, or version. The summary may include, for example, a summary of features, a summary of new features, notable differences between the present version of code and a previous version, features of an update, a summary of compatibility with other software and/or devices being used, and so forth. Based on the summary, a user may decide whether or not to install the code, install the update, upgrade to the new version, etc. Further, at 708, the process 408 may generate and output a recommendation regarding whether to install the code, install the update, upgrade to the new version, etc. In some embodiments, the recommendation may articulate the reasoning behind the recommendation, such as compatibility with other hardware/software, inclusion or exclusion of particular features, and so forth. In some embodiments, providing the recommendation may include generating a graphical representation of the recommendation that is displayable on the client device. Use of the disclosed techniques results in improved performance of computing devices and computing networks as a result of users and/or administrators better understanding features of code, versions, updates, etc. and tuning installations to take advantage of features that are used and/or desired. Further, use of the disclosed techniques results in new service, network, and computing device outages and compatibility of code with other hardware and/or software can be checked before installation.

The presently disclosed techniques are directed to software development and analysis using large language models (LLMs). Prior to using an LLM-based tool for software development and software analysis, a library profiling process is performed. Specifically, code libraries used by an enterprise may be analyzed based on various factors, such as energy consumption to execute code, performance, use cases, etc. In some embodiments, libraries from open source or other publicly available repositories may be analyzed to create baselines and/or expand sample sizes. In such embodiments, APIs may be utilized to extract metadata indicative usage patterns, collect data from logs, and/or survey data about usage. Static analysis tools may then be used to parse code, identify library dependencies, and so forth. Profiles may be generated for libraries identifying various characteristics of the respective library, such as by calculating one or more KPIs for the library. For example, an energy profile may identify energy consumption during typical operations, energy cost/consumption per operation, and compare energy consumption/efficiency to other similar libraries. Similarly, a performance profile may identify execution times to perform certain tasks, resource usage, and so forth. In some embodiments, benchmark tests may be performed to confirm and/or inform the library profiles. Based on the profiles, a multi-criteria decision analysis (MCDA) may be performed to score or rank the various libraries in the various characteristics or KPIs based on weighting factors. The MCDA may be used to recommend libraries for various tasks or use cases. One or more LLMs may be trained using code samples, available libraries, the profiles, user feedback, training data sets, and so forth.

The LLM-based tool may be used by developers during software development. For example, prior to any code being written, the tool may receive inputs describing target characteristics of software to be developed, planned features, etc. and the tool may provide outputs recommending specific libraries, code structures, and so forth. Further, code may be provided via a plugin or API and analyzed. A static analysis of the code may include analyzing the code for known inefficiencies. A dynamic analysis may include running test cases to assess performance, energy consumption, execution time, deviations from security policies and/or security best practices, and so forth in an execution environment. The tool may then be configured to generate various outputs to be used during development. For example, the tool may generate or suggest code snippets to adapt the code to different runtime contexts, reduce performance bottlenecks, convert sequential code into parallel code, implement efficient concurrency patterns, etc. The tool may also be utilized to enhance security by detecting security vulnerabilities, suggesting code adjustments to mitigate security threats, and generating code that follows security policies and/or security best practices. The tool may also be used to improve code maintainability and readability by providing suggestions to simplify complex code structures, generating comments and/or documentation explaining code segments'purpose and functionality, suggesting modifications for compliance with coding standards, performing code review to identify deviations from best practices and suggest corrections, etc. The tool may be used to improve resource usage by recommending more efficient data structures, suggesting improvements to memory allocation/deallocation, suggesting improvements to minimize network usage, suggesting efficient handling of I/O operations to reduce latency and increase throughput, etc. The tool may be used to improve scalability and deployment by providing recommendations on breaking down monolithic applications into microservices to enhance scalability, generating cloud-ready code that utilizes auto-scaling, load balancing, and so forth, generating deployment scripts for deploying the code across multiple environments, suggesting improvements in continuous integration, continuous delivery (CICD) pipelines to streamline code integration and deployment. The tool may be used to improve user experience and responsiveness by suggesting changes to make software more accessible and adhere to standards, providing suggestions for better performance across various devices and screen sizes, analyzing user interaction data and user feedback to recommend changes to the code to enhance the user experience.

Additionally, the tool may be used by consumers to analyze shipped code.

For example, the tool may receive a file or identification of a particular software version and a request for specific analysis. For example, the tool may be configured to provide an explanation of differences between the software version and the previous version. For example, the tool may provide an explanation as to characteristics of a software update and provide a recommendation as to whether the software update should be installed and/or identify possible conflicts or problems that may arise by installing the update.

Technical effects of the disclosed techniques include a more objective, quantitative analysis of software code, resulting in software that is better suited for its objectives. Accordingly, software developed and deployed using the tool may be higher performing, more efficient, more secure, more scalable, or a combination thereof.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving, from a client device associated with an enterprise, information regarding software code;
generating, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library; and
providing, to the client device, the recommendation.

2. The method of claim 1, wherein the plurality of software library profiles comprises a first software library profile that includes a first assessment of an energy consumption during execution of the corresponding software library.

3. The method of claim 2, wherein the plurality of software library profiles comprises a second software library profile that includes a second assessment of a runtime performance of the corresponding software library.

4. The method of claim 1, comprising:
receiving an input comprising a command to implement the recommendation;
revising the software code in accordance with the recommendation; and
providing, to the client device, the revised software code.

5. The method of claim 1, comprising generating the plurality of software library profiles, wherein generating the plurality of software library profiles comprises, for each of the plurality of respective software libraries:
receiving metadata, log data, usage data, or a combination thereof for the respective software library;
parsing one or more portions of code in the software library;
identifying one or more dependencies within the software library, between the software library and one or more of the other software libraries in the plurality of software libraries, or both;
assessing the corresponding KPI associated with usage of the respective software library; and
generating a respective software library profile of the plurality of software library profiles corresponding to the respective software library.

6. The method of claim 1, comprising generating a code snippet to adapt the software code to a different runtime context, reduce performance bottlenecks, convert sequential code into parallel code, implement one or more concurrency patterns, or any combination thereof.

7. The method of claim 1, comprising detecting a security vulnerability in the software code, wherein the recommendation comprises one or more modifications to the code to address the security vulnerability.

8. The method of claim 1, comprising generating comments explaining a purpose, a functionality, or both, of one or more segments of the software code.

9. The method of claim 1, comprising generating deployment scripts for deploying the software code across a plurality of execution environments.

10. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving, from a client device associated with an enterprise, information regarding software code;
generating, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library; and
providing, to the client device, the recommendation.

11. The system of claim 10, wherein the recommendation is to change the software code from using a first software library of the plurality of software libraries to using a second software library of the plurality of software libraries based on the corresponding software library profiles for the first software library and the second software library.

12. The system of claim 10, wherein the recommendation comprises identification of one or more efficient data structures, modifications to memory allocation, modifications to reduce network usage, modifications to input/output (I/O) operations, or any combination thereof.

13. The system of claim 10, wherein the recommendation is to modify the software code to simplify one or more structures of the software code.

14. The system of claim 10, wherein the operations comprise:
receiving an input comprising a command to implement the recommendation;
revising the software code in accordance with the recommendation; and
providing, to the client device, the revised software code.

15. The system of claim 10, wherein the operations comprise: generating the plurality of software library profiles, wherein generating the plurality of software library profiles comprises, for each of the plurality of respective software libraries:
receiving metadata, log data, usage data, or a combination thereof for the respective software library;
parsing one or more portions of code in the software library;
identifying one or more dependencies within the software library, between the software library and one or more of the other software libraries in the plurality of software libraries, or both;
assessing the corresponding KPI associated with usage of the respective software library; and
generating a respective software library profile of the plurality of software library profiles corresponding to the respective software library.

16. A non-transitory, computer readable medium comprising instructions that, when executed by processing circuitry, cause the processing circuitry to perform operations comprising:
receiving, from a client device associated with an enterprise, information regarding software code;
generating, via a large language model (LLM), a recommendation regarding the software code based on the information and a plurality of software library profiles, wherein each of the plurality of software library profiles is associated with a corresponding software library of a plurality of software libraries associated with the enterprise, and wherein each of the plurality of software library profiles indicates a corresponding key performance indicator (KPI) associated with usage of the corresponding software library; and
providing, to the client device, the recommendation.

17. The computer readable medium of claim 16, wherein the providing recommendation comprises generating a graphical representation of the recommendation that is displayable on the client device.

18. The computer readable medium of claim 16, wherein the software code comprises a software update.

19. The computer readable medium of claim 18, comprising identifying one or more consequences of installing the software update on the client device.

20. The computer readable medium of claim 19, wherein the recommendation is whether to install the software update on the client device.
